(19) United States
(12) Patent Application Publication
(10) Pub. No.: US 2002/0103632 A1
(43) Pub. Date: Aug. 1, 2002

(54) Method, program, and tool for updating the national language versions of documents

(75) Inventors: Rabindranath Dutta, Austin, TX (US); Jacob Zachariah, Austin, TX (US)

Correspondence Address: International Business Machines Corporation, Intellectual Property Law Department, Internal Zip 4054, 11400 Burnet Road, Austin, TX, 78758, US

(73) Assignee: International Business Machines Corporation

(21) Appl. No.: 09/773,186

(22) Filed: Jan. 31, 2001

(51) Int. Cl. G06F 17/28

(52) U.S. Cl. 704/2

(57) ABSTRACT

A method is disclosed for expediting delivery of a document in a native language version and National Language versions of the document. An initial level of the native language version is translated into each of the National Language versions using a high quality translation process such as one that includes manual translation by professional translators. Any changes to this initial level are translated using a lower quality translation process such as one that includes only an automatic translation process without any manual translation. Though lower quality, this process has an average translation time per word that is less than the average translation time per word required for a higher quality translation. During the lower quality translation of the changes, an indication is inserted in association with the translated text indicating that the indicated text is not to be regarded as the final translated text, and that a further translation of the lower quality translation will be made available at a later time. This indication is inserted into the document by an automatic translation tool or program that is performing the lower quality translation. The document is first delivered in the native language and in the translated National Language versions where part of a given National language version has text having a high quality translation and other text having a lower quality translation with an indication that a higher quality translation will be available later. Any translated changes having the lower quality translation are translated again using a higher quality translation process and are redelivered at a later time.

### BACKGROUND OF THE INVENTION

1. Field of the Invention

This invention relates to distributing updated documents that have changed content, and more specifically to updating the National Language versions of a native language document that has been changed.

2. Description of the Related Art

The software market is international in scope. To be successful in this international marketplace with a software product, a software provider must simultaneously deliver the software product in many National Language versions. For example, if a U.S. software manufacturer's software product is to be globally available, each translated version of the ReadMe files, User's Guide, and message files should be packaged along with the English (US) version. In many situations, this is difficult for a software manufacturer to achieve. The following scenario illustrates how this difficulty arises.

A U.S. software manufacturer initially creates the software product along with the associated texts, e.g., ReadMe files, User's Guide, and message files, in its native language, e.g., U.S. English. When the product and associated text are completed in English, a copy of the product and/or associated text are sent off to be translated in various different languages within a given deadline.

Typically, documents are translated in two phases. The first phase utilizes an automatic translation tool that automatically converts an original source language into a specific translated target language for which the automatic translation tool is designed. The automatic translation tool may utilize tables or other linking means to associate a given word or phrase in a first language with a corresponding translation in a second language. An automatic translation tool may also automatically rearrange the sentence structure as appropriate for a given language. Since languages can not be directly translated on a word by word basis into another language, these automatic translation tools generally provide only a draft quality translation. To achieve a higher quality translation reflecting a more fluent translation, manual translation is often necessary. As such, after a first phase of automatic translation, a second phase of translation is invoked which utilizes manual translation by professional translators. Although the final manual translation produces fluent text in a translated language, the process is time consuming and subject to the schedule of the translator(s).

The problem occurs when the original, native language version needs to be updated for whatever reason. Quite often after the text was sent out for translation, errors are found in the original version. It may still be possible to make corrections to the original native language version prior to a committed shipping date or release date of the product. However, it may not be possible to get translations of the updated text back in time, also. Consequently, this can either cause delayed shipment of the whole product until the translations are completed, or it can cause extra effort and time in repackaging the product without the National Language versions that do not have the updated translations available. In either case there is at least some, if not a significant amount of, erosion of customer satisfaction for those customers not receiving the product with text in their own language.

### SUMMARY OF THE INVENTION

It is therefore an object of the invention to synchronize National Language Versions of a software product with updates to the original native language version of a software product for simultaneous delivery of the software product in all languages.

The method of the present invention overcomes the problems associated with trying to simultaneously deliver a software product in a variety of different languages, especially when updates to the translated text are required in order to reflect any updates or changes that have been made to the original native language version of the product.

The two phase translation process (automatic translation in conjunction with manual translation) is utilized for the initial drop of the documents. The initial drop is also referred to as the first National Language Version freeze. As such, the first translations of the product are performed using automatic translation and manual translation, or by any other means, to achieve a high quality fluent translation. Once these first translations are performed on the initial drop of the product, if the product has any other changes or updates to it, the translations for these changes or updates are handled initially by using only an automatic translation tool, or other means, that provides merely a draft quality translation that has a lower quality than the high quality fluent translation. In addition, the draft quality translation is provided in a shorter time than the time required to provide a higher quality translation. That is, the lower quality translation process has an average translation time per word (i.e., translation time per number of words being translated) that is less than the average translation time per word required for the high quality translation process. When all changes or updates are translated for each National Language version using automatic translation tools or other lower quality but quicker translation means, then the National Language Versions are ready to be simultaneously delivered with the native language version. Any required manual translation of any National Language Version (NLV) for these subsequent changes or updates is performed at a later time and is delivered separate from the initial delivery such as through the World Wide Web (Web), other Internet means, or through other types of electronic or physical delivery. As such, a high quality translation is performed on the freeze level National Language versions, while only a quicker and lower quality translation methods are used initially on any updates or changes to any previous version having a high quality translation.

An indicator is placed in any document that has only been updated using an automatic translation tool in order to indicate that certain text has only been translated using an automatic translation tool, and that different text resulting from a further manual translation will be available at a later time. This indicator helps explain to a user why certain language in a document may not be as fluently expressed as a user would normally expect it to be. This indicator can be inserted automatically by the automatic translation tool when the automatic translation is being performed on the updates or changes.

The automatic translation tool, which may be implemented as a software program, has a selectable setting that allows a user to enable the automatic insertion of the indicator. The automatic insertion of the indicator is enabled if only a lower quality translation is being performed. The indicator is not automatically inserted if the translation being performed is part of a high quality translation.

The method of the invention, which splits the translation process into two separate phases and coordinates the simultaneous delivery of each NLV of a product after the initial first phase, minimizes any potential for a delayed delivery of a product due to translation time needed to translate updates to the product.

### BRIEF DESCRIPTION OF THE DRAWINGS

For a more complete understanding of the present invention and the advantages thereof, reference should be made to the following Detailed Description taken in connection with the accompanying drawings in which:

FIG. 1 illustrates the process flow for carrying out a preferred embodiment of the invention;

FIG. 2 illustrates a sample document having different portions of text with different quality levels of translation and an indicator indicating that the lower quality translated versions will be further translated and available at a later date; and

FIG. 3 illustrates an automatic translation tool for inserting various indications within a document to indicate that certain text will be further translated to produce a more fluent translation, and will be available later or after a specified date.

### DETAILED DESCRIPTION OF THE PREFERRED EMBODIMENTS

The following described preferred embodiment of the invention may be utilized for delivering documentation in an original native language and in one or more different National Languages. The document may be any item that is capable of being translated. The term document may include, but is not limited to, books, magazines, individual articles, conference or research papers, collections of articles or papers, brochures, advertisement, and software products including user interfaces, manuals, ReadMe files, User Guides, messages, and Help topics. Although the preferred embodiment is described with reference to a software product, the invention is applicable to the delivery of any type of electronic or physical document or collection of documents.

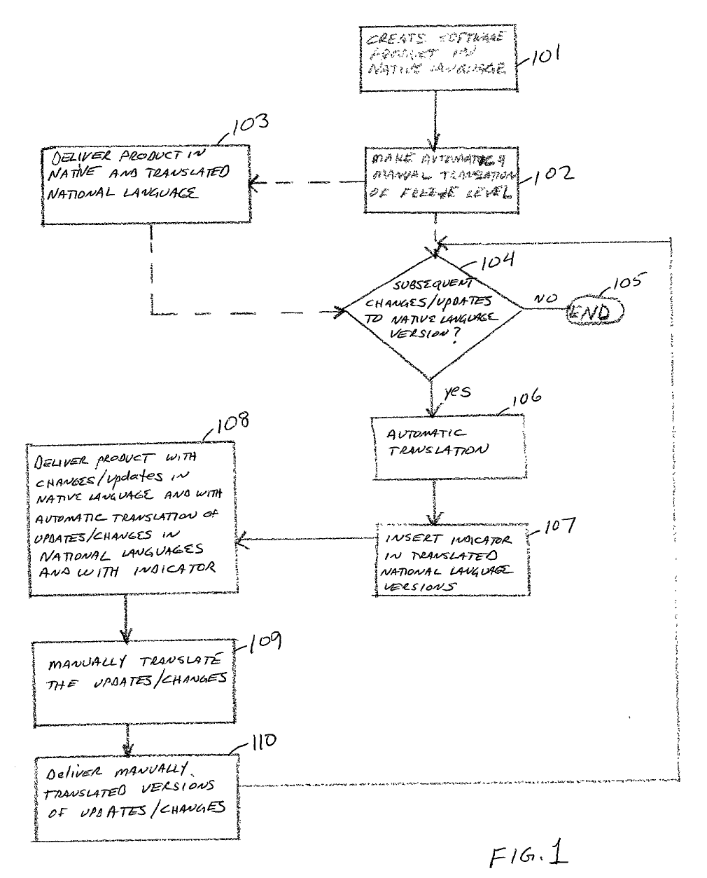

FIG. 1 illustrates the process flow for delivering a software product in a native language and in at least one different National Language. First, a software product, including all of the text associated with the product (e.g., user interfaces, messages, ReadMe files, User Guides, etc.), is created in a native language, 101. Since the creation process is inherently an iterative process, at some point in time the software product is frozen at an initial level. This point in time may be determined by the development level or completeness of the product, or by the time requirements mandated by a set delivery date and any time required beforehand for testing and/or for National Language translations, etc. This freeze level defines the product for which translations in various languages will be made. This freeze level also defines a given level of the product from which changes and updates can be made.

It is this freeze level for which initial National Language translations are made. These translations are made using an automatic translation tool that is specifically designed for each National Language. An example of an automatic translation tool is Systedm Professional Premium, a description of which can be found on the World Wide Web at languagepartners.com/products/mt.htm, which is herein incorporated by reference. Due to the inherent differences between languages, many automatic translation tools are capable of only producing draft quality translations. To achieve a fluent translation for a finished project, a manual translation is then performed to further refine the translation made by the tool. As such, as shown in step 102, the initial freeze version of the product is translated using both automatic and manual translations.

As shown in FIG. 1, step 103 is optional. At this point in time, the product may or may not be delivered. If it is delivered, the native language version of the product is delivered along with the National Language versions that have been automatically and manually translated.

Whether or not this delivery takes place, subsequent steps in the process depend upon whether or not there are any subsequent changes or updates to the product since the freeze of the first initial version, or since a high quality translation has been completed for a previous version, 104. If there are not, the delivery process ends, 105, assuming that the previous delivery, 103, was or will be made before the end, 105. If changes or updates are made, then an automatic translation of the changes or updates to the native language version are made, 106, to create each of the National Language versions. As the automatic translation is being performed, an indicator is inserted in each of the National Language versions to indicate that the translated text was translated using automatic translation and that a further (manual) translation of the changed text will be performed at a later time and delivered later, 107.

The product is then delivered, 108, in the native language with its updates or changes and in each National Language with the updates or changes being only automatically translated. The delivered National Language versions have included within the product the applicable indicators indicating which portions of the text were only automatically translated. After this delivery, the automatic translation of the changes or updates are further translated manually, 109. During the manual translation, the indicators are removed. Then, the National Language versions of the product documentation, for which the updates and/or changes have been automatically and manually translated, are delivered 110.

The process then continues back to step 104 to determine if there are any changes or updates since a complete high quality translation has been made of the previous version.

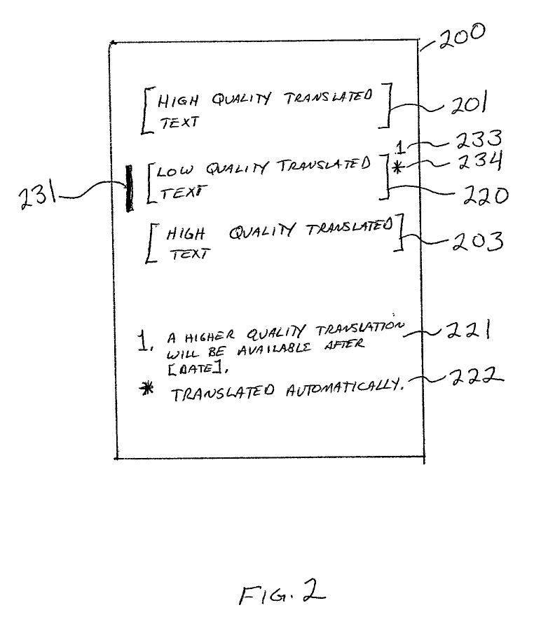

It should be noted, that there are various method and means that can be used to indicate that certain text within a document has only been automatically or roughly translated and that a manual translation or a more fluent translation will be made and/or delivered at a later date. For example, FIG. 2 illustrates a page from a document 200 having a first portion of text 201 and a third portion of text 203 that are high quality translations. The second portion of text 220 represents a lower quality of translation that resulted from a quick translation on any updates or changes to a previous version of the document that was fluently translated. This second portion of text 220 may be highlighted, denoted by a bar 231 in the margin, denoted by a footnote 233 or asterisk 234, bracketed, italicized, etc. Either at a location in close proximity to the automatically translated text, or at a distant location from the automatically translated text but referenced or otherwise linked to it (such as by a footnote), there is a notice 221, 222, that states at least one of the following in some fashion: i) this portion of the text reflects a draft translation; ii) this portion of the text will be further translated (or manually translated) at a later date, where the date may be specifically given; and iii) an updated document will be delivered (by date) after the further translation (or manual translation) is complete.

As such, a National Language Version that reflects updates or changes after the initial freeze version will have high quality translated portions of the document that have correctly translated fluent text such as translations resulting from automatic and manual translations, and lower quality translated portions of the document along with an indication that an improved translation will be available at a later date.

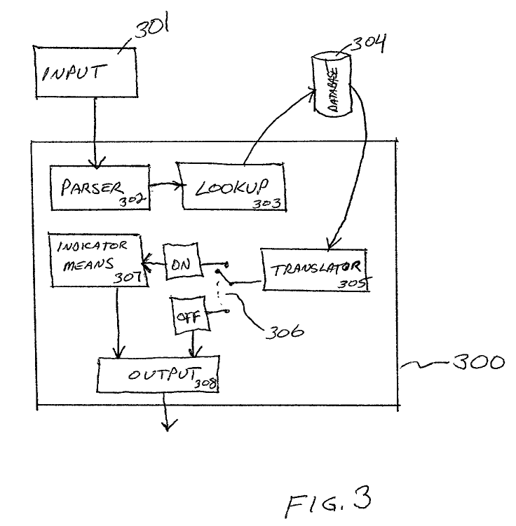

FIG. 3 illustrates an automatic translation tool 300 that has a setting 306 that enables the tool to automatically insert a notice as described above in conjunction with any translated text generated by the automatic translation tool. This setting is set to “on” if only a quick translation is being initially performed on updates or changes. This setting is set to “off” if the automatic translation will be performed in conjunction with manual translation to produce a high quality fluent translation.

The process flow which the tool carries out is described with reference to the functional components of the tool as shown in FIG. 3. The tool receives as input 301 text to be translated. The text is parsed by parser 302. A lookup function 303 is used on the parsed text which utilizes a database 304 of translated words and phrases. The translated words and phrases are then compiled into a translation by the translator 305. If switch 306 is set to “on”, then the tool automatically marks the translated text, using indicator means 307, and associates an indication with the text indicating that the translated text is a lower quality draft translation and that a higher quality translation will be performed at a later date, as described above. The resulting text having high quality translated portions and lower quality translated portions along with the associated indication, as shown in FIG. 2, are sent as output 308 from the tool. If the switch 306 is set to “off”, then the translator sends the resulting translated text to output 308 without inserting any indicators. The translation tool of FIG. 3 is illustrative in nature. More sophisticated translation tools, such as those involving three stages of analysis—syntactic, semantic, and pragmatic—can also be modified with the on/off switch in a similar way for inserting the indicator when desired.

The above described automatic translation tool can be implemented as a software application program running on a computer system having a processor, memory, and an operating system along with other devices including input and output devices. The memory can include both volatile and nonvolatile memory. The look up table or database of translated words and phrases are stored in nonvolatile memory.

It is intended that the scope of the invention be limited not by this detailed description, but rather by the claims appended hereto.

The above specification, examples and data provide a complete description of the method of the invention and any program and/or tool used in conjunction with carrying out the method. Since many embodiments of the invention can be made without departing from the spirit and scope of the invention, the invention resides in the claims hereinafter appended.

Having thus described the invention, what we claim as new and desire to secure by Letters Patent is set forth in the following claims.

1. A method for expediting delivery of a document in a native language and at least one National Language version of the document; the method comprising:
determining an initial level of the native language version of the document;
translating the initial level of the native language version into at least one National Language version having a high quality translation taking a first amount of average translation time per word;
translating given changes to the initial level into the at least one National Language version using a lower quality translation and taking a second amount of average translation time per word less than the first amount of average translation time per word;
indicating, using an indication, in the at least one National Language version at least one of i) that the indicated text is not to be regarded as the final translated text, and ii) a further translation of the lower quality translation will be made available at a later time; and
first delivering the document with the given changes in the native language and in the at least one National Language having the indication.

2. The method of claim 1 wherein the high quality translation results from a manual translation process, and the lower quality translation is void of the manual translation process.

3. The method of claim 1 wherein the high quality translation results from an automatic translation process and a manual translation process, and the lower quality translation results from only an automatic translation process.

4. A method for expediting delivery of a document in a native language and at least one National Language version of the document; the method comprising:
determining an initial level of the native language version of the document;
translating the initial level of the native language version into at least one National Language version using an automatic translation tool and manual translation;
translating given changes to the initial level into the at least one National Language using initially only the automatic translation tool;
indicating in the at least one National Language version that a further translation of the automatically translated changes will be made available at a later time; and
first delivering the document with the given changes in the native language and in the at least one native language having the indication.

5. The method of claim 4 further comprising manually translating the automatic translation of the given changes; and delivering the document with the given changes manually translated at a time later than the first delivery.

6. An automatic translation tool, comprising:
means for receiving text in a first language;
means for automatically translating the received text into translated text; and
means for inserting an indication associated with the translated text indicating at least one of i) that a further translation will be made a different time, ii) that the associated text was translated using automatic translation, iii) that the associated text is a draft translation.

7. A method for translating a document, comprising:
receiving text in a first language;
automatically translating the received text into translated text; and
inserting an indication associated with the translated text indicating at least one of i) that a further translation will be made a different time, ii) that the associated text was translated using automatic translation, iii) that the associated text is a draft translation.

8. A computer program having computer readable program code means on a computer usable medium, comprising:
program means for causing a parsing of text in a first language;
program means for causing a translation of the received text into translated text; and
program code means for causing an indication, associated with the translated text, to be inserted indicating at least one of i) that a further translation will be made a different time, ii) that the associated text was translated using automatic translation, iii) that the associated text is a draft translation.
